(19) United States
(12) Patent Application Publication
(10) Pub. No.: US 2010/0163478 A1
(43) Pub. Date: Jul. 1, 2010

(54) WATER-FLOW FILTERING STRUCTURE

(75) Inventor: Chin-Hua YUAN, Taichung County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: GLOBE UNION INDUSTRIAL CORP., Taichung County (TW)

(21) Appl. No.: 12/345,909

(22) Filed: Dec. 30, 2008

(51) Int. Cl. B01D 36/00

(52) U.S. Cl. 210/251

(57) ABSTRACT

A water-flow filtering structure is provided, including three main built-up members: a filter ring, a water-saving piece, and a water-filtering upper cover, which are removable relative to each other. A plurality of water-filtering holes are disposed in a central region of the water-filtering upper cover, a inner chamber is disposed on an inner side of the water-filtering upper cover for making the water-filtering holes communicate with each other, a control gap is formed between the inner chamber and a throttle body on the water-saving piece, and a plurality of diverging holes are disposed at a periphery of the throttle body of the water-saving piece, so that a water-flow can flow from the respective water-filtering holes of the water-filtering upper cover towards the filter ring via the inner chamber, the control gap and the respective diverging holes.

### BACKGROUND OF THE INVENTION

1. Field of Invention

The invention relates to a water outlet member, more particularly to a water-flow filtering structure that can be applied to a water outlet of a tap.

2. Related Art

Water-flow filtering structure is widely applied, and is commonly mounted at water outlets of various taps. Currently, the common water-flow filtering structure approximately includes a shell body, which can be mounted at a water outlet of a tap, a filter ring, which can be mounted inside the shell body, and a water-flow regulator having a filter screen, which can be mounted within the filter ring. The water-flow regulator has the function of filtering and regulating a water-flow preliminarily. The filter ring has the function of secondarily filtering the water-flow and producing a uniform, mild, and non-splashing water-flow. Furthermore, some filter rings may be provided with slots on their sidewalls, so that a vacuum effect is produced after the water-flow is flowed through the sidewall. Then, air is breathed from the slot to be mixed with the water, impinging on the screen within the filter ring to produce bubbles and water waves. Such a water-flow filtering structure is generally called a bubble-type water-flow filtering structure, and one without the slot is generally called a laminar-flow-type water-flow filtering structure.

Although the common water-flow filtering structure has the functions of filtering and regulating the water-flow, under the requirements of the environment protection and energy saving, how to save the water quantity becomes an extremely important topic. For example, U.S. Patent publication US2006/0144962 discloses a water-flow filtering structure with the concept of water saving. In addition to the conventional shell body, filter ring and water-flow regulator, the water-flow filtering structure further includes a water quantity regulator and a preliminary filter screen. The water quantity regulator includes a core region and an ascending chamfer. The core region surrounds around a throttle body and constitutes a control gap in combination with the ascending chamfer. The core region can be communication-connected to the lower water-flow regulator. Furthermore, the preliminary screen covers on top of the water quantity regulator. As such, the water-flow can flow towards the water-flow regulator through the primary filtration of the preliminary screen and the control gap. Wherein, when the water-flow flowing through the preliminary screen is enhanced, the water-flow will impinge on the throttle body on the water quantity regulator to produce outward-diffusion and deformation, making the control gap smaller, thereby a water-saving effect of regulating the water quantity can be achieved.

However, the Patent above has the following shortcomings. First, although the water-flow filtering structure has the water-saving function, it adds a water quantity regulator compared to the conventional water-flow filtering structure, thus it needs to increase a molding mold and an assembly procedure, increasing the production and assembly cost relatively. Second, in the water-flow filtering structure, water-filtering holes are not only distributed in a central region of the preliminary screen, but also distributed at a periphery of the preliminary screen. In addition, the periphery of the preliminary screen is opposite to the ascending chamfer around the water quantity regulator in a small gap. Hence, when the water-flow flows through the respective water-filtering holes of the preliminary screen, especially flows through the water-filtering holes at the periphery of the preliminary screen, an impinging water flow will be produced on the ascending chamfer, so that the preliminary screen is liable to encounter a counteracting force of the impinging water-flow and ascends upward to produce a drifting or floating phenomena, thereby resulting in deflection. Furthermore, impurities and foreign matter contained in the water also easily accumulates on the ascending chamfer, then jams in the small gap between the ascending chamfer and the preliminary screen to cause deflection of the preliminary screen, thereby influencing the smoothness of water outlet and the effect of water filtering. Third, in a practical use of the water-flow filtering structure, it is found that an evident noise is still produced due to the impinging of the water-flow, especially after the water-flow flows through the control gap. Because no special water flow resistance is designed, the water-flow rapidly flows through the water-flow regulator, and impinges on the screen in the filter ring to produce the evident noise. In view of the several shortcomings of the Patent above, there does exist a great space to be improved.

### SUMMARY OF THE INVENTION

A primary object of the present invention is directed to a water-flow filtering structure. It is expected that the water-flow filtering structure can effectively reduce the number of built-up members to reduce the production and assembly cost, while keeping the original function of filtering and water saving.

A secondary object of the present invention is directed to a water-flow filtering structure. It is expected that the water-flow filtering structure can reduce a counteracting force of the impinging produced by a water-flow on a water-filtering upper cover, to prevent the water-filtering upper cover from deflecting due to drifting or floating. It is also expected that the water-flow filtering structure can reduce the deflection of the water-filtering upper cover due to jamming of impurities and foreign matter in the water, to ensure the quality of water-flow filtering and the smoothness of water outlet.

A further object of the present invention is directed to a water-flow filtering structure. It is expected that the water-flow filtering structure can provide a proper guide and a resistance limitation for the water-flow after the water-flow flows through a control gap formed between the water-filtering upper cover and a water-saving piece, to achieve an effect of lowering the flow speed to reduce the noise.

In order to achieve the objects above, the present invention provides a water-flow filtering structure, including:

a filter ring;

a water-saving piece, detachably mounted at a front side of the filter ring along a flow direction, a core region is disposed in a center thereof, the core region surrounds around a throttle body, and a plurality of diverging holes are disposed at a periphery of the core region;

a water-filtering upper cover, detachably mounted at a front side of the water-saving piece along the flow direction, a plurality of water-filtering holes are disposed throughout an outside central region thereof, an inner chamber is defined on an inner side thereof for making the water-filtering holes communicate with each other, the inner chamber is separated from the throttle body of the water-saving piece by a control gap, the inner chamber can be in communication with the lower respective diverging holes.

The water-flow filtering structure further includes a shell body, for mounting and positioning the filter ring.

The filter ring of the water-flow filtering structure further includes a body and a plurality of filter screens; the body has an inner space for mounting and positioning the screens in the below, and a circular top edge; a sidewall of the water-saving piece can be properly embedded into the inner space, and an annular positioning edge is extended around the water-saving piece, the annular positioning edge can be positioned against the circular top edge.

A step edge is disposed at a periphery of the upper respective diverging holes of the water-saving piece in the water-flow filtering structure, and an annular positioning edge positioned against the step edge is relatively disposed at a periphery of the water-filtering upper cover.

A top setting surface of the respective diverging holes of the water-saving piece of the water-flow filtering structure is separated from an opposite bottom surface of the water-filtering upper cover by a predetermined distance.

The core region in the center of the water-saving piece of the water-flow filtering structure is formed by a columnar structure axially being extended upward from a center of the top surface.

The core region of the water-flow filtering structure has a first columnar portion with a large diameter located in the below, and a second columnar portion being extended from a center of the first columnar portion. The throttle body detachably covers and surrounds around the second columnar portion and supported by a top surface of the first columnar portion.

A plurality of choke columns are distributed around the first columnar portion of the water-flow filtering structure. Flow intervals with predetermined sizes are formed between the choke columns, and between the choke columns and the first columnar portion. The diverging holes are disposed in a peripheral region of the choke columns.

A plurality of guiding blocks as a whole are extended from an outer sidewall of the first columnar portion of the water-flow filtering structure in a circumferential direction by a predetermined interval. The guiding block is at least partially located at a periphery of the throttle body relatively.

The choke columns of the water-flow filtering structure include a plurality of choke columns located in an inner region, and a plurality of choke columns located in a peripheral region. Each of the choke columns in the inner region is relatively disposed between any two adjacent guiding blocks in an adaptive flow interval respectively. Each of the choke columns in the inner region is respectively arranged with two peripheral choke columns in a symmetrical triangle shape.

Utilizing the water-flow filtering structure of the present invention, first, since only two built-up members (the water-filtering upper cover and the water-saving piece) can achieve the filtering and water-saving effects obtained by three built-up members of the conventional water-flow filtering structure (the preliminary screen, the water-flow regulator, and the water quantity regulator), the structure can be effectively simplified and thus reduces the production and assembly cost. Second, since the water-filtering holes of the water-filtering upper cover are distributed only in the central region relative to the inner chamber, the counteracting force of the impinging of the water-flow on the water-filtering upper cover after the water-flow flows through the water-filtering holes can be reduced, thereby preventing deflecting due to drifting or floating. Also, a design of replacing the conventional ascending chamfer by the inner chamber can avoid the accumulation of impurities and foreign matter in the water to cause the water-filtering upper cover to be jammed, resulting in a deflecting situation, which also can ensure the smoothness of water outlet and the effect of water filtering. Third, the flow intervals with proper sizes are formed between the outer sidewall of the first columnar portion, the respective two adjacent guiding blocks and the respective choke columns of the water-saving piece under the control gap, and between the respective guiding columns in the inner region and the respective guiding columns in the peripheral region, furthermore, the respective diverging holes are disposed at the periphery of the choke columns, consequently, after the water-flow flows through the control gap, the water-flow will be subject to route guiding and resistance limitation by the flow intervals, so that the flow speed of the water-flow is effectively slowed down, thereby achieving the effect of reducing the noise.

### BRIEF DESCRIPTION OF THE DRAWINGS

The present invention will become more fully understood from the detailed description given herein below for illustration only, and thus are not limitative of the present invention, and wherein:

FIG. 1 is an overall outside view of the water-flow filtering structure according to a first embodiment of the present invention;

FIG. 2 is a detailed three-dimensional exploded view of the water-flow filtering structure according to the first embodiment of the present invention;

FIG. 3 is a general three-dimensional exploded view of the water-flow filtering structure according to the first embodiment of the present invention;

FIG. 4 is a side sectional view of the water-flow filtering structure according to the first embodiment of the present invention;

FIG. 5 is a three-dimensional outside view of a water-saving piece without a throttle body according to the present invention;

FIG. 6 is a schematic diagram of a flow direction according to the present invention, in which a water-flow flows from a water-filtering upper cover according to the first embodiment of the present invention, through the water-saving piece to a filter ring;

FIG. 7 is a schematic diagram of a part of a flow direction according to the present invention, in which a water-flow flows through a control gap of the water-flow filtering structure according to the first embodiment of the present invention, flows into between the respective two adjacent guiding blocks, through the flow intervals formed between the guiding blocks and the respective choke columns, towards the respective diverging holes; and

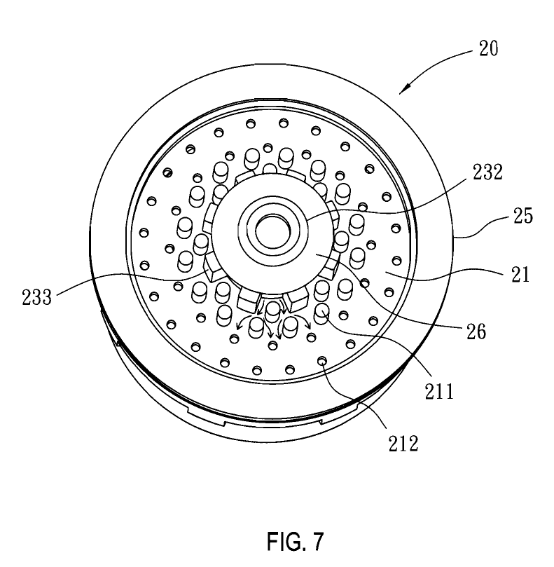

FIG. 8 is an overall outside view of the water-flow filtering structure according to a second embodiment of the present invention.

### DETAILED DESCRIPTION OF THE INVENTION

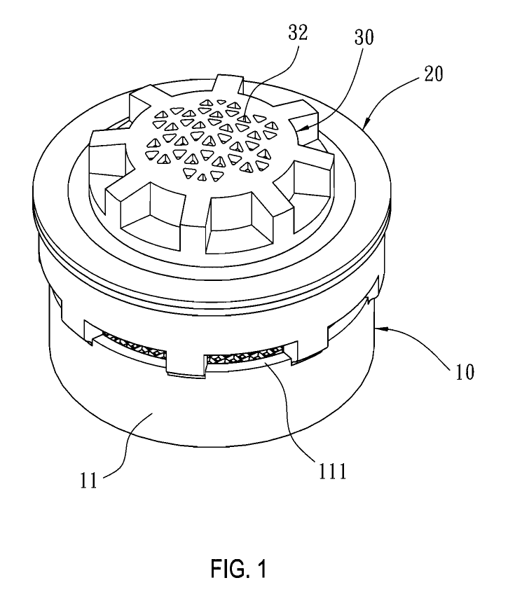

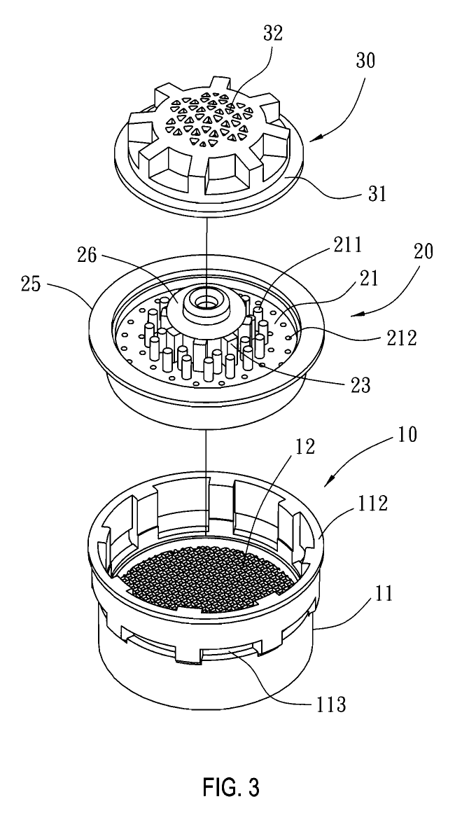

FIG. 1 to 4 illustrates the water-flow filtering structure according to a first embodiment of the present invention. The water-flow filtering structure mainly includes a shell body (not shown), a filter ring 10, a water-saving piece 20, and a water-filtering upper cover 30. The built-up members are illustrated below respectively.

The shell body is usually spirally mounted and fixed to a water outlet of a predetermined water-outlet member, such as tap. The shell body is a conventional member, and not a main technical characteristic of the present invention.

The filter ring 10 is detachably mounted and positioned inside the shell body. The filter ring 10 of this embodiment includes a body 11, and four filter screens 12 mounted and positioned inside the body 11 in a posterior position along the flow direction. The body 11 has an inner space 111 and a circular top edge 112. A plurality of slots 113 in communication with outside are disposed on a sidewall of the body 11, so that a vacuum effect is produced when a water-flow flows through the body 11, and thus air is breathed from the slots 113 to be mixed with the water-flow, impinging on the screens 12 to produce bubbles and water waves. The filter ring 10 is a conventional member, and not a main technical characteristic of the present invention.

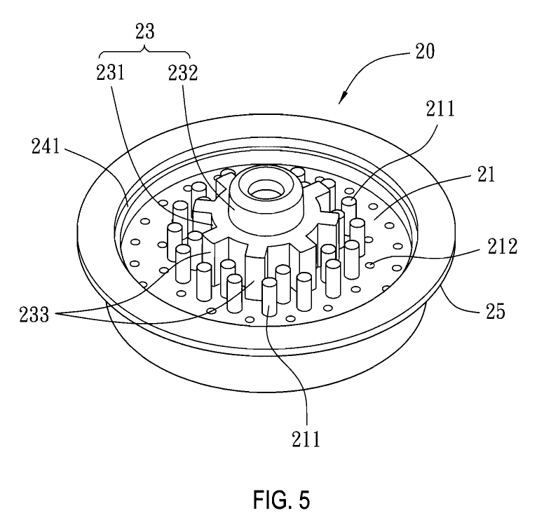

Further referring to FIG. 5, it can be found that the water-saving piece 20 is detachably mounted inside the filter ring 10 at a front side along the flow direction. The water-saving piece 20 includes a top surface 21, a bottom surface 22, a core region 23 axially being extended upward from a center of the top surface 21, a sidewall 24 being extended upward from a periphery of the top surface 21, and an annular positioning edge 25 being horizontally extended outward from the sidewall 24. The water-saving piece 20 can be positioned against the top edge 112 of the filter ring 10 by the annular positioning edge 25. The core region 23 of this embodiment is a columnar structure, and approximately includes a first columnar portion 231 with a large diameter located in the below and a second columnar portion 232 being extended from a center of the first columnar portion 231. A throttle body 26, which may be an O-ring, is supported on a top surface of the first columnar portion 231, and the throttle body 26 detachably covers and surrounds around the second columnar portion 232. Furthermore, a plurality of guiding blocks 233 as a whole are extended from an outer sidewall of the first columnar portion 231 in a circumferential direction by a proper interval. The guiding block 233 is at least partially or entirely located at a periphery of the throttle body 26 relatively. A plurality of choke columns 211 projecting upward from the top surface 21 are distributed around the first columnar portion 231. Flow intervals with proper sizes are formed between the choke columns 21, and between the choke columns 21 and the outer sidewall of the first columnar portion 231, the guiding block 233. The choke columns 211 of this embodiment are distributed in a circular shape with the first columnar portion 231 as the center. The choke columns 211 include a plurality of choke columns 211 located in an inner region and a plurality of choke columns 211 located in a peripheral region, each of the choke columns 211 in the inner region is relatively disposed between any two adjacent guiding blocks by an adaptive flow interval respectively, and each of the choke columns 211 in the inner region is respectively arranged with two choke columns 211 in the peripheral region in a symmetrical triangle shape. Also, a plurality of diverging holes 212 are disposed on the top surface 21 in the peripheral region of the choke columns 211 of the water-saving piece 20, the diverging holes 212 pass through the bottom surface 22 and can communicate with the screens 12 inside the filter ring 1O. A step edge 241 is disposed on a top inner side of the sidewall 24 of the water-saving piece 20.

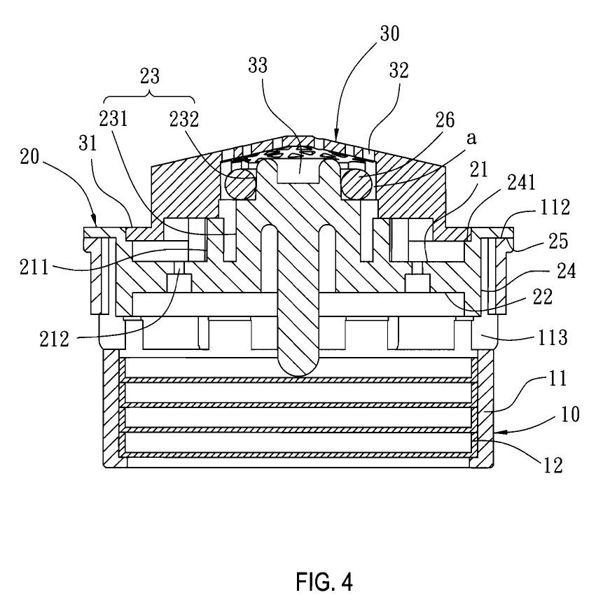

The water-filtering upper cover 30 is detachably mounted at a front side of the water-saving piece 20 along the flow direction. In this embodiment, an annular positioning edge 31 is extended around the water-filtering upper cover 30 horizontally, for positioning the step edge 241 of the water-saving piece 20 against the annular positioning edge 31. Furthermore, a plurality of water-filtering holes 32 are disposed throughout a central region of an outer top surface of the water-filtering upper cover 30, and an inner chamber 33 is defined on an inner side of the water-filtering upper cover 30 for making the water-filtering holes 32 communicate with each other. Further, the inner chamber 33 is separated from the throttle body 26 of the water-saving piece 20 by a control gap a, as shown in FIG. 4, the inner chamber 33 can be in communication with the lower respective diverging holes 212. Also, the bottom surface of the inner side of the water-filtering upper cover 30 in the periphery of the inner chamber 33 is properly positioned against the top edges of the respective guiding blocks 233 and the choke columns 211 of the first columnar portion 231 of the water-saving piece 20, so that the water-flow flowing through the control gap a can be guided to flow into between the respective two adjacent guiding blocks 233, through the flow intervals formed by the guiding blocks 233, the respective inner choke columns 211 and the respective peripheral choke columns 211, to the respective diverging holes 212.

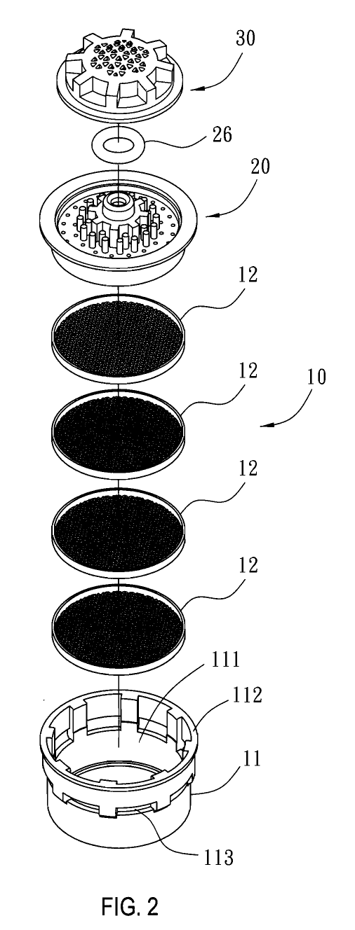

Referring to FIG. 2 to 4, in assembly of the water-flow filtering structure of the present invention, at first, the throttle body 26 covers and surrounds around the second columnar portion 232 of the water-saving piece 20, and the throttle body 26 is positioned against the top edge of the first columnar portion 231. Then, the annular positioning edge 25 around the water-saving piece 20 is positioned against the top edge 112 of the filter ring 10. Thereafter, the annular positioning edge 31 of the water-filtering upper cover 30 is positioned against the step edge 241 of the water-saving piece 20, thus the assembly of the main members of the water-flow filtering structure is accomplished. Finally, the main members above are placed into the shell body, and spirally fixed onto a water outlet of a predetermined water-outlet member, thus the mounting operation of the water-flow filtering structure is accomplished.

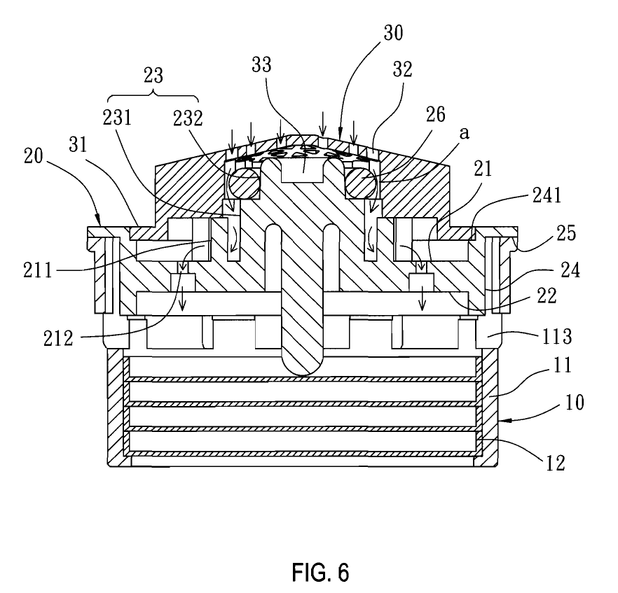

Referring to FIG. 6, in use of the water-flow filtering structure of the present invention, when a water-flow flows towards the water outlet of the water outlet member, the water-flow first enters the inner chamber 33 inside the water-flow filtering structure from the respective water-filtering holes 32 in the central region of the water-filtering upper cover 30, then through the control gap a between the inner chamber 33 and the throttle body 26 on the water-saving piece 20, flows in order into the flow intervals between the outer sidewall of the first columnar portion 231, the respective two adjacent guiding blocks 233 and the respective relative inner choke columns 211 of the water-saving piece 20, then, flows along the flow intervals between the inner choke columns 211 and the peripheral choke columns 211 towards the peripheral respective diverging holes 212, finally, flows in order through the respective diverging holes 212 and the respective screens 12 of the filter ring 10 out of the water outlet, and produces a bubbly water-flow with bubble and water wave effect.

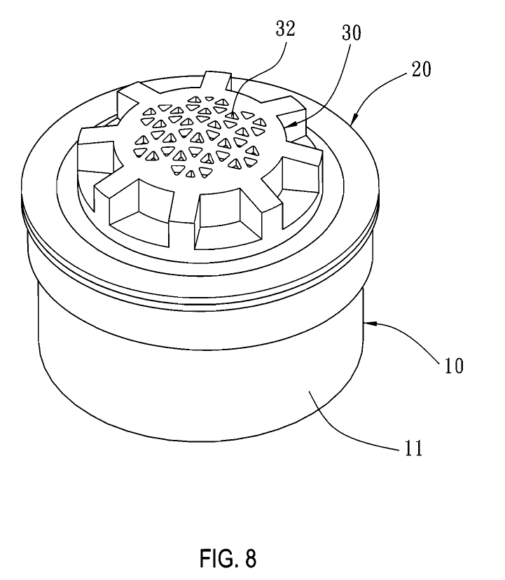

Referring to FIG. 8, the water-flow filtering structure of a second embodiment of the present invention is shown. It is approximately the same as the water-flow filtering structure of the first embodiment above, except that the above slots 113 are not designed on the sidewall of the filter ring 10. Consequently, when a water-flow flows through the filter ring 10, the vacuum effect and the water outlet effect with bubbles and water waves will not be produced. Rather, the laminar-flow-type water-outlet effect is achieved; accordingly, the present invention is also suitable as the laminar-flow-type water-flow filtering structure.

In view of the description above, the features and effect of the present invention is generalized as follows:

1. The water-flow filtering structure of the present invention expertly combines the core region and the throttle body portion of the water-flow regulator and the water quantity regulator in the conventional water-flow filtering structure into a water-saving piece 20, utilizes the sidewall of the inner chamber 33 inside a water-filtering upper cover 30 to surround around the throttle body 26 by a proper interval, instead of the ascending chamfer of the conventional water quantity regulator, to form the desired control gap a, so three built-up members (the water-flow regulator, the water quantity regulator and the preliminary screen) of the conventional water-flow filtering structure can be simplified as two built-up members (the water-saving piece 20 and the water-filtering upper cover 30). Accordingly, the present invention can effectively reduce the number of built-up members while keeping the original filtering and water-saving functions, and thus can reduce the development and fabrication of molding molds and the assembly procedure, thereby reducing the production and assembly cost.

2. In the water-filtering upper cover 30 of the water-flow filtering structure of the present invention, since the water-filtering holes 32 are designed to be only distributed in the central region relative to the inner chamber 33, in contrast to the all-round distribution design in the conventional water-flow filtering structure, the design can reduce the impinging from the water-flow after the water-flow flows through the water-filtering holes 32, thereby reduces the counteracting force upward encountered by the water-filtering upper cover 30, so that the water-filtering upper cover 30 is not deflected due to drifting or floating. Furthermore, the sidewall of the inner chamber 33 is used instead of the conventional ascending chamfer. In the design, there is no elongate gap formed between the conventional ascending chamfer and the preliminary screen, preventing the water-filtering upper cover from being deflected due to jamming of impurities and foreign matter in the water. Accordingly, the smoothness of water outlet and the effect of water filtering can be ensured.

3. The present invention utilizes the following designs. Flow intervals with proper sizes are formed between the outer sidewall of the first columnar portion 231, the respective two adjacent guiding blocks 233 and the respective inner choke columns 211, and between the inner choke columns 211 and the peripheral choke columns 211 in the water-saving piece 20 under the control gap a, and the respective diverging holes 212 are located at the periphery of the choke columns 211. By these designs, after the water-flow flows through the control gap a, the water-flow is subject to the route guiding and the resistance limitation by the flow intervals, so that the flow speed is slowed down, and thus the noise is reduced. In contrast, in the conventional water-flow filtering structure, the water-flow rapidly flows through the diverging holes 212 without hindrance after the water-flow flows the control gap, resulting in the evident noise.

4. The water-flow filtering structure of the present invention is obtained only by improving the three built-up members of the conventional water-flow regulator, water quantity regulator, and preliminary screen, so the filter ring 10 with the slots 113 in the sidewall or being sealed may be optionally combined. Accordingly, the water-flow filtering structure of the present invention is broadly suitable as the bubble-type or laminar-flow-type water-flow filtering structure.

In summary, the present invention has an excellent progressive utility over the same type of products, and no identical structure is found in technical documents relating to this type of structure at home and abroad. Accordingly, the present invention conforms to the requirements for a utility model patent.

However, the foregoing are only several preferred feasible embodiments of the present invention, and all equivalent changes made according to the specification and the claims should be within the scope of the present invention.

What is claimed is:

1. A water-flow filtering structure, comprising:
a filter ring;
a water-saving piece, detachably mounted at a front side of the filter ring along a flow direction, a core region is disposed in a center thereof, the core region surrounds around a throttle body, and a plurality of diverging holes are disposed at a periphery of the core region;
a water-filtering upper cover, detachably mounted at a front side of the water-saving piece along the flow direction, a plurality of water-filtering holes are disposed throughout an outside central region thereof, an inner chamber is defined on an inner side thereof for making the water-filtering holes communicate with each other, the inner chamber is separated from the throttle body of the water-saving piece by a control gap, the inner chamber can be in communication with the lower respective diverging holes.

2. The water-flow filtering structure according to claim 1, further comprising a shell body, for mounting and positioning the filter ring.

3. The water-flow filtering structure according to claim 1, wherein the filter ring further comprises a body and a plurality of filter screens; the body has an inner space for mounting and positioning the screens in the below, and a circular top edge; a sidewall of the water-saving piece can be properly embedded into the inner space, and an annular positioning edge is extended around the water-saving piece, the annular positioning edge can be positioned against the circular top edge.

4. The water-flow filtering structure according to claim 1, wherein a step edge is disposed at a periphery of the upper respective diverging holes of the water-saving piece, and an annular positioning edge positioned against the step edge is relatively disposed at a periphery of the water-filtering upper cover.

5. The water-flow filtering structure according to claim 1, wherein a top setting surface of the respective diverging holes of the water-saving piece is separated from an opposite bottom surface of the water-filtering upper cover by a predetermined distance.

6. The water-flow filtering structure according to claim 1, wherein the core region in the center of the water-saving piece is formed by a columnar structure being extended axially upward from a center of a top surface.

7. The water-flow filtering structure according to claim 1, wherein the core region has a first columnar portion with a large diameter located in the below, and a second columnar portion being extended from a center of the first columnar portion, the throttle body detachably covers and surrounds around the second columnar portion and supported by a top surface of the first columnar portion.

8. The water-flow filtering structure according to claim 7, wherein a plurality of choke columns are distributed around the first columnar portion, flow intervals with predetermined sizes are formed between the choke columns, and between the choke columns and the first columnar portion, the diverging holes are disposed in a peripheral region of the choke columns.

9. The water-flow filtering structure according to claim 8, wherein a plurality of guiding blocks as a whole are extended from an outer sidewall of the first columnar portion in a circumferential direction by a predetermined interval, and the guiding block is at least partially located at a periphery of the throttle body relatively.

10. The water-flow filtering structure according to claim 9, wherein the choke columns comprise a plurality of choke columns located in an inner region, and a plurality of choke columns located in a peripheral region, each of the choke columns in the inner region is relatively disposed between any two adjacent guiding blocks by an adaptive flow interval respectively, and each of the choke columns in the inner region is respectively arranged with two peripheral choke columns in a symmetrical triangle shape.

11. The water-flow filtering structure according to claim 1, wherein a plurality of choke columns are distributed at the periphery of the core region of the water-saving piece, the flow intervals with predetermined sizes are formed between the choke columns, and between the choke columns and the core region, and the diverging holes are disposed in a peripheral region of the choke columns.

12. The water-flow filtering structure according to claim 11, wherein a plurality of guiding blocks as a whole are extended from an outer sidewall of the core region in a circumferential direction by a predetermined interval, and the guiding block is at least partially located at a periphery of the throttle body relatively.

13. The water-flow filtering structure according to claim 12, wherein the choke columns comprise a plurality of choke columns located in an inner region, and a plurality of choke columns located in a peripheral region, each of the choke columns in the inner region is relatively disposed between any two adjacent guiding blocks by an adaptive flow interval respectively, and each of the choke columns in the inner region is respectively arranged with two peripheral choke columns in a symmetrical triangle shape.
